(19) United States
(12) Patent Application Publication
(10) Pub. No.: US 2009/0273945 A1
(43) Pub. Date: Nov. 5, 2009

(54) MODULAR, LUMINOUS, SMALL FORM-FACTOR SOLID-STATE LIGHTING ENGINE

(75) Inventors: Brian C. Lowry, Ernlenton, PA (US); David Sheffield, Virginia Beach, VA (US); Clark Shotwell, Bonita Springs, FL (US)

Correspondence Address: FERENCE & ASSOCIATES LLC, 409 BROAD STREET, PITTSBURGH, PA, 15143, US

(73) Assignee: Megapull, Inc., Mooresville, NC (US)

(21) Appl. No.: 12/433,409

(22) Filed: Apr. 30, 2009

Related U.S. Application Data
(60) Provisional application No. 61/049,338, filed on Apr. 30, 2008.

(51) Int. Cl. G02B 6/42; G02B 6/36

(52) U.S. Cl. 362/555; 385/92

(57) ABSTRACT

The invention comprises a small form-factor solid-state light engine that provides uniform lighting with high efficiency. The invention provides uniform lighting by practically eliminating any “dead spot” produced by conventional light engines. The invention produces light more effectively and thus fewer light engines need to be employed in a given lighting arrangement. The invention is modular, easily accommodating fiber optics of various sizes and shapes with minimal modification to the components of the light engine.

### CLAIM FOR PRIORITY

This application claims priority from U.S. Provisional Patent Application No. 61/049,338, filed Apr. 30, 2008, which is hereby incorporated by reference in its entirety as if fully set forth herein.

### FIELD OF THE INVENTION

The invention is directed to lighting arrangements. Specifically, the invention is directed to modular, small from-factor, solid-state light engines suitable for use in a broad variety of lighting applications.

### BACKGROUND OF THE INVENTION

A light engine can be defined broadly as the integration of a light-emitting device (e.g., one or more LEDs), a mounting substrate (e.g., printed circuit board), and other components necessary for the device's operation (e.g., heat sink, power connections, optics). Some light engines are designed specifically for use in conjunction with one or more optical fibers. These are often called “fiber optic illuminators.” A second category of light engine is that designed for use without fiber optics. Often times, these units are “chained” together electrically for ease of installation. They are typically referred to as “light modules.” Numerous solid-state light engines from both categories have entered the market. These products are primarily targeted at the general illumination market and more specifically at incandescent and fluorescent lamp replacement where the solid-state light engines have distinct advantages in power consumption, durability, and longevity.

The form-factor of these conventional light engines is typically large and constrained by the form-factor that is being replaced, e.g., MR16, MR11, E27, etc. For certain types of lighting, it is ideal to hide the light source from view. For example, when using light engines to illuminate a decorative fiber optic cable, such as found around the perimeter of a pool or building, one does not wish to see the “dead spot” created by the light engine. Similarly, if a light engine is being used to internally illuminate a channel letter, the presence of the light engine within the channel letter will cause an undesirable “dead spot” to appear on the face of the channel letter.

Conventional solid state light engines providing light to an optical fiber are quite large. A conventional solid state light engine will have a “footprint” of 15-40 in². The conventional light engine form-factor is one of an elongated cylinder. One reason for this is that light engines equipped with light emitting diodes (LEDs) as a light source need an effective way to deal with the heat produced by the LEDs. LEDs produce a large quantity of heat that must be dissipated, as by use of a heat sink. Conventional light engines employ large heat sinks, and often times a small fan, contributing to the rather large form-factor of conventional light engines, without regard to the resultant “dead spot” contribution of such an arrangement.

Conventional light engines designed for use in conjunction with optical fiber also use additional components, such as a gland or a cord grip for holding the lighting fiber (e.g. a side-emitting optic fiber). These components are necessary, as for example when providing a watertight light engine in certain applications. This is particularly important in the case of lighting placed in an environment encountering water, e.g. perimeter lighting for a pool or spa. Conventionally, these components contribute to the dead spot in the overall lighting arrangement, as they obstruct the passage of light there through.

Consequently, the conventional light engines produce undesirable “dead spots”, as the components of the light engine are not themselves luminescent. As can be appreciated by those having ordinary skill in the art, this problem is compounded in certain lighting arrangements, e.g. channel letters, when a series of light engines are provided. A series of dead spots will be produced. Thus, conventional lighting arrangements suffer from numerous “dead spots”, often requiring the use of many light engines.

Conventional light engines also suffer from an inability to be easily adapted to accommodate different components without significant modification. Accordingly, conventional light engine components cannot be combined easily with one another because, for example, fiber optics of different sizes and shapes require unique fitting arrangements to ensure secure attachment to a light source (e.g. LED). The luminaries controlling the dispersion of light from the LED are constrained to their original design. Thus, a light engine that is designed to replace an MR16 lamp will need to be redesigned for an E27 fixture. While this is justified by the goal of low-cost and mass production, it does not address the needs of the specialty illumination markets where standard fixtures are sub-optimal.

Accordingly, the inventors have recognized a need for improving conventional lighting arrangements, accounting for the above-described deficiencies.

### SUMMARY OF THE INVENTION

At least one presently preferred embodiment of the invention provides a modular, luminous, small form-factor solid-state light engine that provides uniform lighting with high efficiency. The invention provides uniform lighting by practically eliminating any “dead spot” produced by conventional light engines. The invention disburses light more effectively and thus fewer light engines need to be employed. The invention is modular, easily accommodating fiber optics of various sizes and shapes with minimal modification to the components of the light engine, and its components can be scaled easily according to the chosen implementation requirements.

In summary, one aspect of the present invention provides an apparatus comprising: a light transmitting optics barrel configured to house at least one non-light transmitting component of a light engine such that the at least one non-light transmitting component does not interfere with indirect transmission of light by the translucent optics barrel.

Another aspect of the present invention provides a light engine comprising: a heat sink; a printed circuit board thermally coupled to the heat sink; at least one light emitting diode disposed on the printed circuit board; secondary optics configured to direct light emitted from the at least one light emitting diode to at least one optic fiber; and a light transmitting optics barrel having a first end and a second end; wherein the first end is configured to house a securing mechanism configured to interchangeably secure a variety of sizes of optic fibers; and wherein the second end is configured to house the secondary optics.

A further aspect of the present invention provides a method comprising: arranging components of a light engine suitably to direct light from at least one light emitting diode to at least one optic fiber; and housing at least one non-light transmitting component of the light engine within a light transmitting optics barrel such that the at least one non-light emitting component does not interfere with indirect emission of light by the light transmitting optics barrel.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 illustrates “dead spots” produced in a channel letter by conventional light engines.

FIG. 2 illustrates an exploded view of a light engine according to one embodiment of the invention.

FIG. 3 illustrates a side-on view of a light engine according to one embodiment of the invention.

FIG. 4 illustrates and front-on view of a light engine according to one embodiment of the invention.

FIG. 5 illustrates a side-on view of a light engine according to one embodiment of the invention.

FIG. 6 illustrates light movement within a light engine according to one embodiment of the invention.

FIG. 7(A-B) illustrates of a light engine(s) having an optical fiber inserted according to embodiments of the invention.

FIG. 8 illustrates a unidirectional mount for the light engines according to one embodiment of the invention.

FIG. 9 illustrates a serial lighting arrangement according to one embodiment of the invention.

### DETAILED DESCRIPTION OF THE PREFERRED EMBODIMENTS

It will be readily understood that the components of the present invention, as generally described and illustrated in the figures herein, may be arranged and designed in a wide variety of different configurations in addition to the described presently preferred embodiments. Thus, the following more detailed description of the embodiments of the present invention, as represented in the figures, is not intended to limit the scope of the invention, as claimed, but is merely representative of selected presently preferred embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings. The following description is intended only by way of example, and simply illustrates certain selected presently preferred embodiments of devices, systems, processes, etc. that are consistent with the invention as claimed herein.

As outlined above, what is needed in the industry is a modular light engine that can be inexpensively and quickly modified to fit a variety of custom applications and that avoids producing undesirable “dead spots” in practical application. The great number of light engines currently employed in practice consume a large amount of energy and/or provide many points of failure. Moreover, the large size of conventional light engines that use fiber optics makes their use in many applications (e.g. small signs) impractical, for at least the reason that undesirable “dead spots” appear throughout the overall lighting arrangement.

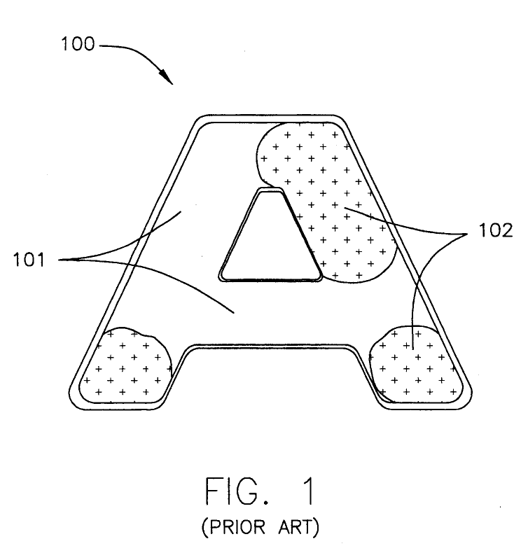

FIG. 1 illustrates an exemplary conventional lighting arrangement having “dead spots” (101). As shown, the channel letter (100) lighting arrangement, as for example an outdoor sign, needs to be illuminated. This is conventionally accomplished by placing light engines inside the channel letter (100). In this arrangement, for example, many different light engines are employed to provide adequate illumination to the channel letter (100). As above, use of conventional light engines leads to difficulties.

One difficulty is the need to employ a large number of light engines for such a lighting arrangement. For example, typically two to four light engines (with multiple LED's per light engine) are used per running foot for a stroke width less than 8″. This magnitude of light engines is required because conventional light engines are inefficient in terms of uniformly dispersing light. This naturally leads to increased cost, both in the components needed for providing adequate illumination and in the energy consumed by these components. This is compounded by the fact that each light engine tends to be constrained to a particular implementation due to incompatibility between variable component sizes.

A most notable difficulty relating to the channel letter's (100) outside appearance is that a plurality of “dead spots” (101) appear throughout the channel letter (100). These “dead spots” (101) are created by the absence of adequate lighting in these areas of the channel letter (100). This is the product of employing conventional light engines having large heat sinks, often 10 in³ or more, and other components that are not luminescent. Thus, a plurality of over-lit areas (102) also appear, giving the channel letter (100) an overall non-uniform lighting, e.g. as measured at various points along the surface of the channel letter (100).

In contrast to conventional arrangements, at least one presently preferred embodiment of the instant invention provides a modular solid-state light engine wherein the luminous distribution can be easily modified by interchangeable light transmitting components so as to be used in a wide variety of lighting applications. The light transmitting components can be for example transparent or preferably translucent. The invention is constructed using predominantly translucent or transparent (i.e. light transmitting) thermoplastic components (e.g. optic barrels) that are designed to capture a portion of the light emitted (e.g. by one or more LEDs) indirectly, causing a majority of the volume of the light engine to emit light. This in practice leads to an elimination of “dead spots”. Thus, the components of the invention effectively hide other necessary components that would conventionally contribute to “dead spots” because they do not allow light to be transmitted/emitted. The light transmitting (e.g. translucent) optics barrel (and other light transmitting components) are utilized to allow light indirectly captured from the light source (e.g. LED) to be more efficiently transmitted by the light engine, thereby eliminating any “dead spots”.

In addition, at least one embodiment of the invention employs a secondary means of occluding the light engine by employing a design whereby the light engine itself is as small as possible. According to at least one embodiment, the light engine proper (i.e. from the heat sink to the end of the optics barrel) has a “footprint” of <4.5 in². The light engine is no more than approximately two inches in length. The bottom width of the light engine proper is no more than approximately 2.5 inches in width, including the heat sink. The thickness of the heat sink itself is reduced to approximately 0.5 inch. The diameter of the optics barrel is approximately 1 inch. Thus, the invention provides a small form-factor light engine that emits light over a significant portion of its volume, thus mitigating the “dead spot” effect encountered with conventional light engines.

As described further below, the invention provides light engines configurable in a wide variety of ways, further mitigating the “dead spots” produced in lighting arrangements. Scalability is achieved by utilizing modular components that can be customized (e.g. via injection molding, etc.) and interchanged, as desired. It should be noted that the presently preferred embodiments described below are only by way of example.

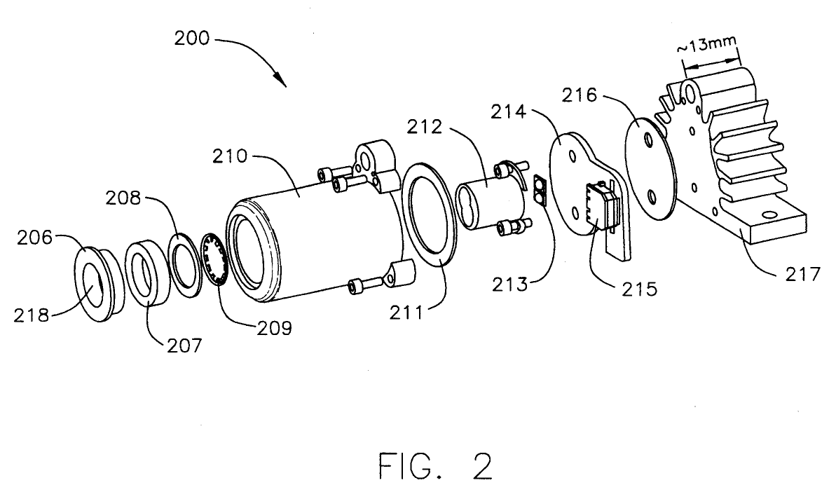

FIG. 2 illustrates an exploded view of an exemplary light engine (200) according to an embodiment of the invention. In this example, the light engine (200) is comprised of the following main components: one or more LEDs (two are shown in the figure) (213), a printed circuit board (214), power supply attachment (215), a heat sink (217), an interchangeable light transmitting optics barrel (210), secondary optics (212) (which is a compound spherical reflector in this non limiting example), an insert (206), a metal toothed retaining washer (209) and a deformable O-ring (207). These and other notable components of the light engine are described further below; however, it should be noted that this is only a non-limiting example and other components consistent with the invention, as claimed, may be utilized in certain applications.

The LED (213) is presently preferred to be a commercial, off-the-shelf, high flux, high power LED, such as manufactured by Lumileds® Corp., Cree Inc., Seoul Semiconductor Inc., Nichia Corp., Osram GmbH, etc. The present example utilizes the Lumileds® Rebel® LED. If thermal and size constraints of the printed circuit board (PCB) (213) are met, more than one LED may be used in each light engine. Very small form-factor LED's, such as the Lumileds® Rebel® LED, are one such example.

The LED (213) is disposed on the printed circuit board (PCB) (214), preferably being reflow-soldered or attached with thermal epoxy. Due to the high power of LEDs (213), the PCB (214) must have low thermal resistance (e.g. a “metal-clad” PCB). Heat dissipative materials, such as aluminum and ceramic are ideal substrates for the PCB (214). Ideally, the PCB (214) is white in color to maximize light reflection. A thermal contact (216) thermally connects the PCB (214) to the heat sink (217).

A power supply connecting portion (215) is provided on the PCB (214). Power supply wires (not shown) may be directly soldered to the PCB (214), or preferably, may be connectorized so that jumpers or wiring harnesses may be used to simplify wiring. A sealing gasket (211) is also provided ensuring a water tight seal.

The small (e.g. 13 mm) heat sink (217) (a radial fin heat sink, as shown) dispels heat from the LED junction. An aluminum alloy heat sink (217) is presently preferred due to its heat dissipation properties. The heat sink (217) is designed to operate at high ambient temperatures. The heat sink (217) may have mounting provisions (e.g. screws and holes therefor) so that the light engine (200) can be oriented upward facing or side facing, as desired. Several heat sinks may be ganged together for large-area illumination, as described further below.

An interchangeable light transmitting optics barrel (210) is provided. The light transmitting optics barrel (210) attaches to the heat sink (217) via threads, tabs, interference fit, or some other means. The light transmitting optics barrel (210) may be machined or preferably injection molded to lower cost into essentially any desired shape, as dictated by the particular application. The light transmitting optics barrel (210) materials that are presently preferred are LDPE (low-density polyethylene), HDPE (high-density polyethylene), acrylic, polycarbonate, polystyrene, though some other translucent or transparent engineered thermoplastic may be utilized as well. Stray light from the LED (213) (not captured by the optics, as described below) and back reflection cause an indirect transmission of light from the light transmitting optics barrel (210) according to an embodiment of the invention. This indirect transmission of light practically eliminates “dead spot” production. A secondary function of the light transmitting optics barrel (210) is to provide ingress protection to the LED (213) and optics path.

According to at least one embodiment of the invention, the front end of the light engine comprises the light transmitting optics barrel (210) (comprised of a plurality of parts including but not limited to an outer sleeve and an inner barrel which is constrained by the secondary optics (212)), an insert (206), a deformable o-ring (207), a spacer (208), and a metal-toothed retaining washer (209). In this embodiment, the outer sleeve of the light transmitting optics barrel (210) is identical irregardless of the secondary optics (212) chosen. The decision whether to use single or multiple components for the light transmitting optics barrel is purely economical.

The insert (206) fits into the light transmitting optics barrel (210). The insert (206) is preferably itself composed of light transmitting (e.g. translucent) material, as discussed with regard to the light transmitting optics barrel (210) above. Preferably, a deformable O-ring (207) acting as a gasket, a spacer (208) and a metal-toothed retaining washer (209) are provided in between the insert (206) and the light transmitting optics barrel (210), as shown. The optic fiber (not shown) is inserted through the opening (218) and positioned to collect light emitted by the LED (213). The deformable O-ring (207) helps to ensure a water tight seal to the front end of the light engine (200). It has been discovered that upon insertion of the optic fiber (not shown), the deformable O-ring (207), if composed of a material such as rubber, may tend to deform to an unacceptable degree unless some additional means or some alternative material is utilized. In this non-limiting example, a spacer (208) composed of some rigid material (e.g. a metal) is employed to ensure that the deformable O-ring (207) maintains an appropriate shape upon insertion of the optic fiber (not shown).

The optic fiber (not shown) needs to be secured upon insertion into the opening (218) of the light engine (200). Thus, a retaining mechanism is employed to secure the optic fiber within the opening (218) of the light engine (200). The retaining ring may be a thermoplastic, rubber, or metallic ring, or a combination of these elements, which holds the optic fiber in proper alignment to the LED (213) and optics and provides ingress protection for the LED (213). An embodiment of the invention utilizes a combination of deformable o-ring (207), spacer (208), and metal-toothed retaining washer (209), as well as a thermoplastic end cap insert (206) as the retaining mechanism for an interference fit in the light transmitting optics barrel.

In this non-limiting example, a metal-toothed retaining washer (209) is employed such that the teeth of the metal-toothed retaining washer (209) are biased to permit easy insertion of the optic fiber (not shown) into the opening (218) yet not permit extraction of the optic fiber. It will be readily appreciated by those having ordinary skill in the art that the size of opening (218) and the constituent components can be easily modified such that a wide variety of optic fibers can be employed. Particularly, insert (206) may be provided with any of a wide variety of differently sized openings (218) and metal-toothed retaining washers (209) so that the light engine (200) may easily accommodate a variety of optic fibers. Moreover, the light engine may, as discussed above, accommodate any of a wide variety of LEDs for different applications. This includes but is not limited to variable color LEDs and optic fibers therefore. Thus, at least one embodiment of the invention is a modular light engine (200) that can easily be modified by changing a fraction of the component parts.

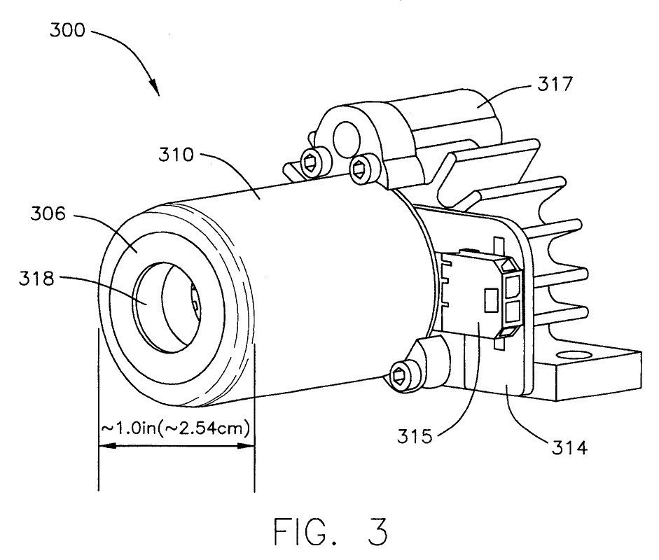

FIG. 3 illustrates a side-on view of a modular, luminous, small form-factor solid-state light engine according to one embodiment of the invention. The small heat sink (317) and the light transmitting optics barrel (310) enclose at least one LED (not shown) disposed on the PCB (314). The PCB (314) receives power through connector (315). At the front end of the light transmitting optics barrel (310) is shown the insert (306), which is preferably composed of light transmitting material, thus mitigating any light interfering properties of additional components (e.g. the deformable O-ring and metal toothed retaining washer). An optical fiber (not shown) can be inserted through opening (318) in the insert (306). The small size of this exemplary light engine (300) is indicated by the measurement of the light transmitting optics barrel (310) diameter, which in this particular implementation is preferably about 1 inch.

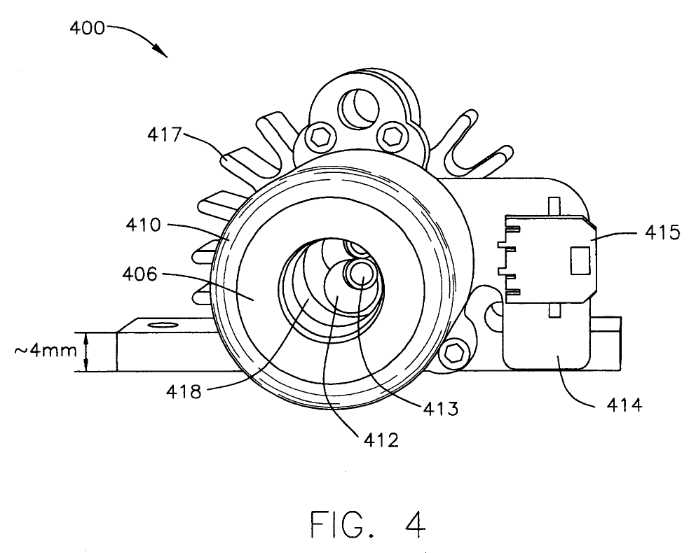

FIG. 4 illustrates an exemplary light engine (400) according to one embodiment of the invention. The light engine (400) is shown in a front-on view of the light engine depicted in FIG. 3, i.e. looking down the opening (418) in the inset (406) positioned within the light transmitting optics barrel (410), towards the secondary optics (412) and the underlying LED (413). The small heat sink (417) is shown at the rear of the light engine (400), thermally coupled to the PCB (414) that receives power via a connector (415). The relative size of the small heat sink is indicated by the measurement of the heat sink base thickness, as shown on the order of 4 mm.

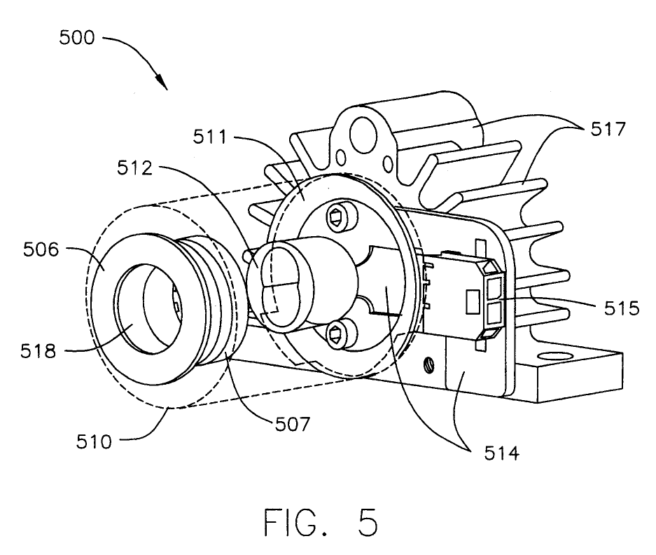

FIG. 5 illustrates a side-on view of the light engine depicted in FIG. 3, with the light transmitting optics barrel (510) removed as indicated by the dotted lines. This view allows one to appreciate the compact nature of this particular embodiment of the invention, as it shows the components (save the spacer, which is optional) illustrated in FIG. 2 (exploded view) as connected. At the front end of the light engine (500) is the insert (506). The insert (506) retains the deformable O-ring (507) and the metal toothed washer. Together, these components create a retention mechanism for an optical fiber (not shown) upon insertion into opening (518). The optical fiber (not shown) will be optically coupled to the LED (not shown) via the secondary optics (512). Again, the small heat sink (517) is thermally connected to the PCB (514) that receives power via connector (515). The light engine is water tight via the deformable O-ring (507) and the gasket (511).

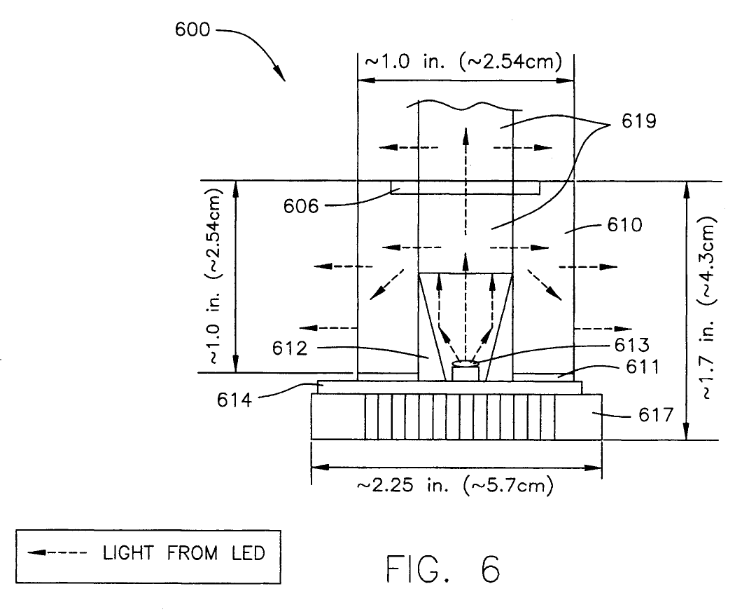

FIG. 6 illustrates a cross-sectional view of a light engine according to one embodiment of the invention. The LED (613), consisting of a light-emitting area fabricated upon a die, is covered by a protective lens. (LEDs are processed in wafer form similar to silicon-integrated circuits, and broken out into dice (singular die)). The light-emitting portion of the LED is a fraction of the total die area, encapsulated with epoxy or silicone. The dome-shaped lens refracts light from the LED and so acts as the primary optics for the light engine. Secondary optics (612), both refractive and reflective, are located in the light transmitting optics barrel (610) for the purpose of further controlling the luminous distribution. This is typically necessary since LED's distribute light into a large cone, often in the order of 120°. The design of the secondary optics (612) is application dependent. The light engine (600) can be made water tight at the junction of the light transmitting optics barrel (610) and the PCB (614), as in this example by employing a gasket (611).

Light may be launched from LED (613) into an optical fiber (619). Secondary optics (612) focus the LED light to an annular area in the optical fiber (619). The light, indicated throughout FIG. 6 with a dashed arrow, is directed by the secondary optics (612) in an appropriate direction for the given application. As shown, light will enter the optical fiber (619). The optical fiber (619) could be for example a side emitting optic fiber. Light will also pass through the light transmitting optics barrel (610) in a plurality of directions. Thus, both the light transmitting optics barrel (610) and the fiber optic (619) will provide light to the lighting arrangement. The light thus provided emanates from a very large majority of the overall light engine (600), with the only portion not explicitly providing light being the small heat sink (617).

The choice of secondary optics, as above, depends on the particular application. As the light transmitting optical barrel (610) can accommodate a wide variety of off the shelf secondary optics (612), the light engine (600) is suitable for a wide variety of applications. Moreover, as discussed above, the light transmitting optical barrel (610) and associated modular components (e.g. insert (606)) allow for a wide variety of optical fibers or light guides to be utilized. Non-limiting examples of different secondary optics and light guides are discussed below.

As a non-limiting example, to efficiently couple light from an LED to a large core fiber or light guide, or to a plurality of smaller light guides whose cross-section is larger than the diameter of the LED, a parabolic or elliptical reflector is prescribed. This is effective for example where the light is launched from an LED into a 10 mm diameter optical light guide. An elliptical reflector is used to focus the LED light to an annular area in the large core fiber. The light is directed by the secondary optics along the longitudinal extension of the light pipe for the purpose of causing light to travel the length of the light pipe. The reflector may be injection molded ABS with a vacum-metalized coating.

In another non-limiting example, a reflective lens is chosen for secondary optics. The lens is, for example, an injection molded PMMA (poly-meth-methacrylate) part that is designed to focus light down to a cross-sectional area that is less than or equal to the diameter of the LED. In this example, an off the shelf lens (e.g. a fiber light injector lens (FFLI) from Fraen Corp.) may be used to couple the LED to a 6.5 mm diameter flexible solid core optical fiber.

A lens may of course be chosen such that use of additional secondary optics is unnecessary. As a non-limiting example, an off the shelf anamorphic Fresnel lens may be used to distribute the LED light in an asymmetrical manner without any additional coupling components for coupling the LED to a light guide.

In the above examples, reference has been made to a light guide. The light guide may be any optical waveguide, such as an optic fiber, whether rigid or flexible, side-emitting or end-emitting, preferably with circular cross-section for optimal coupling to the LED. A plurality of smaller-diameter waveguides may be used as well, joined together at the light engine by epoxy and or a ferrule. According to one embodiment of the invention, a light guide is optional and thus is not necessary. For example, one could use a “spot” lens and with this invention as a down/spot light without the use of fiber/light guide.

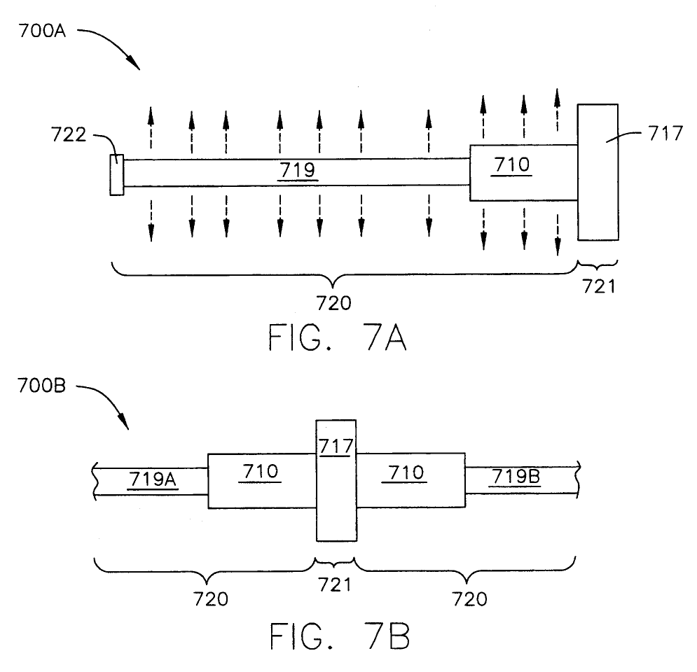

FIG. 7A illustrates the extent to which any “dead spot” is reduced to insignificance by a light engine (700a) in accordance with one embodiment of the invention. As shown, the light transmitting optical barrel (710) and the optic fiber (719) both provide light, with a cap (722) acting to reflect light at the end of the optic fiber (719). This leads to a large majority of the light engine (700a) as being capable of provisioning light. The area of the light engine (700a) capable of providing light is represented by bracket (720). Thus, the only portion of the light engine (700a) not explicitly providing light is the small heat sink (717). The heat sink is small as compared to conventional heat sinks, e.g. on the order of 13 mm. In practice, the small heat sink (717) is sufficiently small such that the light engine (700a) as a whole does not produce a “dead spot”.

FIG. 7B depicts a double-sided light engine (700b) arrangement according to one embodiment of the invention. The double-sided light engine (700b) uses a single heat sink (717) and two optical fibers (719a, 719b). This arrangement is ideal for creating linear, “double-pumped” lighting systems such as borders. Since the heat sink (717) thickness significantly reduced (e.g. is less than or equal to 13 mm in thickness), the “dead spot” created by the heat sink (717) is not noticeable at normal viewing distances.

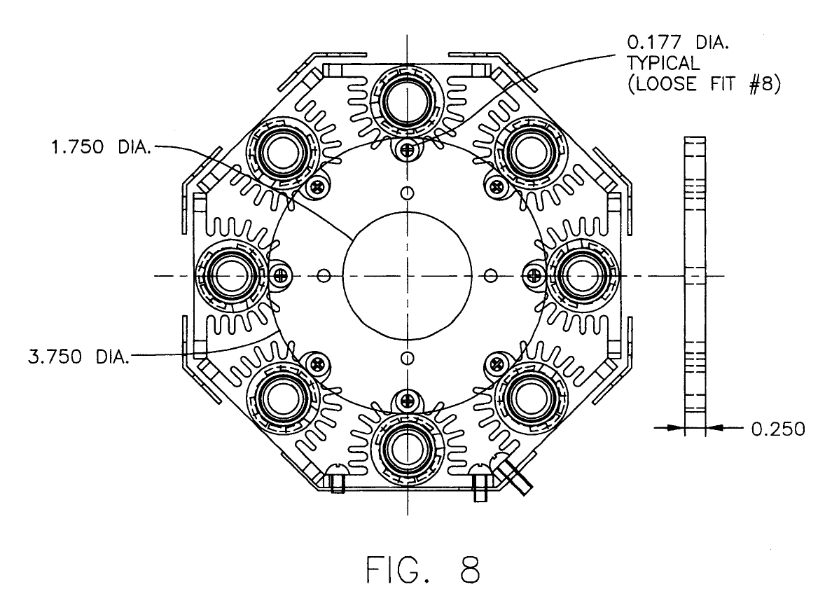

FIG. 8 demonstrates a high-density, unidirectional mount for the light engines (800) that is useful for example as a flood lamp, wall-washer, or spot light depending on the secondary LED optics employed. As shown, the small form-factor of the light engines (800) facilitate mounting a series of light engines (800) in a relatively small area. In this example, the light engines (800) are mounted on a mounting bracket (824). The light engines (800) may be fixed to the mounting bracket (524) by way of screws placed through holes in the heat sinks (817). The light engines can be arranged in any of a wide variety of configurations, for example as shown in FIG. 8 in a circular arrangement about a mounting flange (823), which itself may be utilized to fix the overall lighting arrangement to a structure (e.g. a wall, not shown).

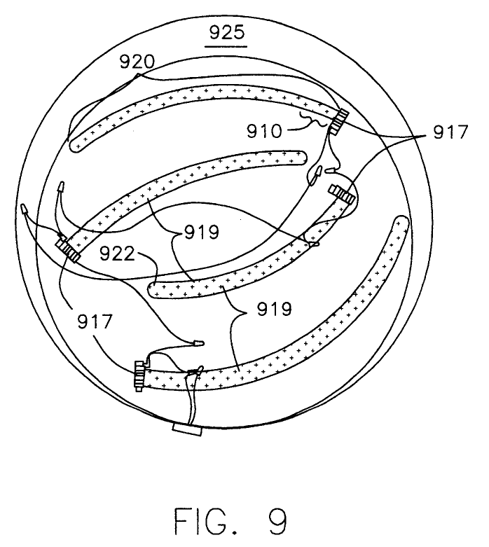

FIG. 9 illustrates a serial lighting arrangement according to one embodiment of the invention. As shown, a series of light engines are arranged within a “can” (925) of a sign with the front face removed for ease of viewing. Overall, the majority of the light engine(s) is providing light because of the small size of the heat sink (917) and the use of light transmitting light engine components, such as the light transmitting optics barrel (910), which capture light indirectly and transmit it. The use of the light transmitting optics barrel (910), a side-emitting optical fiber (919) and a reflector cap (922) result in an efficient dispersion of light that allows for placement of several small form-factor light engines within the can (925) of a sign. The small form-factor of the light engines allows them to be easily retained within the sign, as dictated by the particular implementation. Appropriate wiring provides power to the PCB in such a serial arrangement, which provides a uniform lighting of the sign, eliminating the appearance of “dead spots”. Naturally, more or fewer light engines of varying sizes can be employed depending upon the particular application and desired lighting level, energy consumption, etc.

In brief recapitulation, at least one presently preferred embodiment of the invention provides a modular, luminous, small form-factor solid-state lighting engine. The invention provides practical elimination of “dead spots” found in conventional lighting arrangements by implementation of light transmitting components, such as a light transmitting optics barrel, such that a large majority of the light engine is caused to provide illumination. The invention also allows the overall luminous distribution of a lighting arrangement to be easily modified as desired for any of a wide variety of applications. The invention achieves modularity, for example, by provisioning of interchangeable components.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

In the drawings and specification there has been set forth a preferred embodiment of the invention and, although specific terms are used, the description thus given uses terminology in a generic and descriptive sense only and not for purposes of limitation.

If not otherwise stated herein, it is to be assumed that all patents, patent applications, patent publications and other publications (including web-based publications) mentioned and cited herein are hereby fully incorporated by reference herein as if set forth in their entirety.

What is claimed is:

1. An apparatus comprising:
a light transmitting optics barrel configured to house at least one non-light transmitting component of a light engine such that the at least one non-light transmitting component does not interfere with indirect transmission of light by the translucent optics barrel.

2. The apparatus according to claim 1, wherein a first end of the light transmitting optics barrel is configured to house a securing mechanism configured to interchangeably secure a variety of sizes of optic fibers.

3. The apparatus according to claim 2, wherein the securing mechanism further comprises a metal toothed washer.

4. The apparatus according to claim 1, wherein the light transmitting optics barrel is configured to interchangeably house secondary optics therein.

5. The apparatus according to claim 1, wherein the light transmitting optics barrel is configured to connect to a heat sink.

6. The apparatus according to claim 5, wherein:
the at least one light emitting diode is disposed on a printed circuit board; and
the light transmitting optics barrel is configured to cover the at least one light emitting diode so as to not admit water.

7. A light engine comprising:
a heat sink;
a printed circuit board thermally coupled to the heat sink;
at least one light emitting diode disposed on the printed circuit board;
secondary optics configured to direct light emitted from the at least one light emitting diode to at least one optic fiber; and
a light transmitting optics barrel having a first end and a second end;
wherein the first end is configured to house a securing mechanism configured to interchangeably secure a variety of sizes of optic fibers; and
wherein the second end is configured to house the secondary optics.

8. The light engine according to claim 7, wherein the securing mechanism further comprises a metal toothed washer configured to inhibit removal of at least one optic fiber upon insertion of the at least one optic fiber into the first end of the light transmitting optics barrel.

9. The light engine according to claim 7, wherein the light transmitting optics barrel is configured to house the securing mechanism such that the securing mechanism does not interfere with indirect emission of light from the at least one light emitting diode by the light transmitting optics barrel.

10. The light engine according to claim 8, wherein the securing mechanism further comprises: a deformable o-ring; a translucent insert; and a spacer.

11. The light engine according to claim 7, wherein a thickness of the heat sink does not exceed 13 mm.

12. The light engine according to claim 7, wherein the light transmitting optics barrel is configured to cover at least one non-light transmitting component of the light engine.

13. The light engine according to claim 7, wherein the first end of the light transmitting optics barrel is configured to accept the translucent insert.

14. The light engine according to claim 7, wherein an overall length of the light engine is less than 5 inches; and wherein an overall width of the light engine is less than 4 inches.

15. The light engine according to claim 7, wherein the light engine is a modular, luminous, small form-factor solid-state light engine.

16. A method comprising:
arranging components of a light engine suitably to direct light from at least one light emitting diode to at least one optic fiber; and
housing at least one non-light transmitting component of the light engine within a light transmitting optics barrel such that the at least one non-light emitting component does not interfere with indirect emission of light by the light transmitting optics barrel.

17. The method according to claim 16, further comprising providing a printed circuit board having the at least one light emitting diode disposed thereon.

18. The method according to claim 17, further comprising directing light emitted from the at least one light emitting diode with secondary optics housed within the light transmitting optics barrel to the at least one optic fiber.

19. The method according to claim 16, further comprising dissipating heat produced by the at least one light emitting diode with a heat sink.

20. The method according to claim 19, wherein a thickness of the heat sink is no more than 13 mm.
